(19) United States
(12) Patent Application Publication
(10) Pub. No.: US 2012/0313734 A1
(43) Pub. Date: Dec. 13, 2012

(54) Folded coaxial radio frequency mirror

(75) Inventors: Adam W. Schreiber, Fredericksburg, VA (US); Louis F. DeChiaro, JR., Middletown, DE (US)

(73) Assignee: United States Government, as represented by the Secretary of the Navy, Arlington, VA (US)

(21) Appl. No.: 12/924,026

(22) Filed: Sep. 17, 2010

(51) Int. Cl. H01P 7/04

(52) U.S. Cl. 333/222

(57) ABSTRACT

A coaxial mirror is provided for reflecting an electromagnetic signal. The mirror includes an outer pipe, an inner pipe, and first and second rods. The outer pipe extends between input and output ports, with closed initial and final terminals disposed at their respective ports. The inner pipe extends between a closed fore end and an open aft end. The inner pipe is coaxially disposed between the initial and final terminals within the outer pipe. The first rod, coaxially disposed within the outer pipe, extends from the input port to the fore end. The second rod, coaxially disposed within the inner pipe, extends from downstream of the fore end to the output port. Preferably, the first and second pipes are cylindrical tubes. Preferably, fluoropolymer fills the annular region between the inner and outer pipes, and fluoropolymer foam fills the inner pipe. Preferably, the first pipe has an electrically conductive inner surface, the second pipe has electrically conductive inner and outer surfaces, and the first and second rods have conductive surfaces. A first embodiment includes a conductor, coaxially disposed within the inner pipe, that extends from the fore end to the second rod. In a second embodiment, the second rod is hollow, and is preferably filled with the foam.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to coaxial radio frequency (RF) mirrors. In particular, the invention relates to a more convenient design intended for field application.

Radar applications incorporate narrow-band filtering under inelastic scattering in which a strong continuous-wave transmission signal at a transmit wavelength encounters a target that returns a faint echo at a return wavelength slightly shifted from the transmit wavelength. (This condition contrasts from elastic scattering that lacks the wavelength shift in return signal.) The radar receiver thus listens for a weak return signal near the frequency of the stronger transmit signal. Narrow-band filtering employs co-axial RF mirrors to reflect the signal through a gain medium to enable detection.

### SUMMARY

A coaxial RF mirror can be employed to provide narrow-band filtering. However, conventional RF mirrors lack qualities that facilitate field use due to design constraints that render these delicate and awkward.

Conventional coaxial RF mirrors yield disadvantages addressed by various exemplary embodiments of the present invention. In particular, the exemplary embodiments described herein improve the ability to field such electromagnetic reflectors with increased ruggedness and reduced length.

Various exemplary embodiments provide a coaxial mirror for reflecting an electromagnetic signal. The mirror includes an outer pipe, an inner pipe, and first and second rods. The outer pipe extends between input and output ports, with closed initial and final terminals disposed at their respective ports. The inner pipe extends between a closed fore end and an open aft end. The inner pipe is coaxially disposed between the initial and final terminals within the outer pipe. The first rod, coaxially disposed within the outer pipe, extends from the input port to the fore end. The second rod, coaxially disposed within the inner pipe, extends from downstream of the fore end to the output port.

Preferably, the first and second pipes are cylindrical tubes. Preferably, fluoropolymer fills the annular region between the inner and outer pipes, and fluoropolymer foam fills the inner pipe. Preferably, the first pipe has an electrically conductive inner surface, the second pipe has electrically conductive inner and outer surfaces, and the first and second rods have conductive surfaces. In various exemplary embodiments, the mirror includes a conductor, coaxially disposed within the inner pipe, that extends from the fore end to the second rod. In alternate exemplary embodiments, the second rod is hollow, and is preferably filled with the foam.

### BRIEF DESCRIPTION OF THE DRAWINGS

These and various other features and aspects, of various exemplary embodiments will be readily understood with reference to the following detailed description taken in conjunction with the accompanying drawings, in which like or similar numbers are used throughout, and in which:

FIG. 1 is an elevation cross-sectional view of an RF mirror;

FIG. 2 is a tabular view of dimensions and material properties of sections in the mirror;

FIG. 3 is a block diagram of a narrow band-pass filter that employs the mirror;

FIG. 4 is an elevation cross-sectional view of an alternate RF mirror; and

FIG. 5 is a tabular view of dimensions and material properties.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

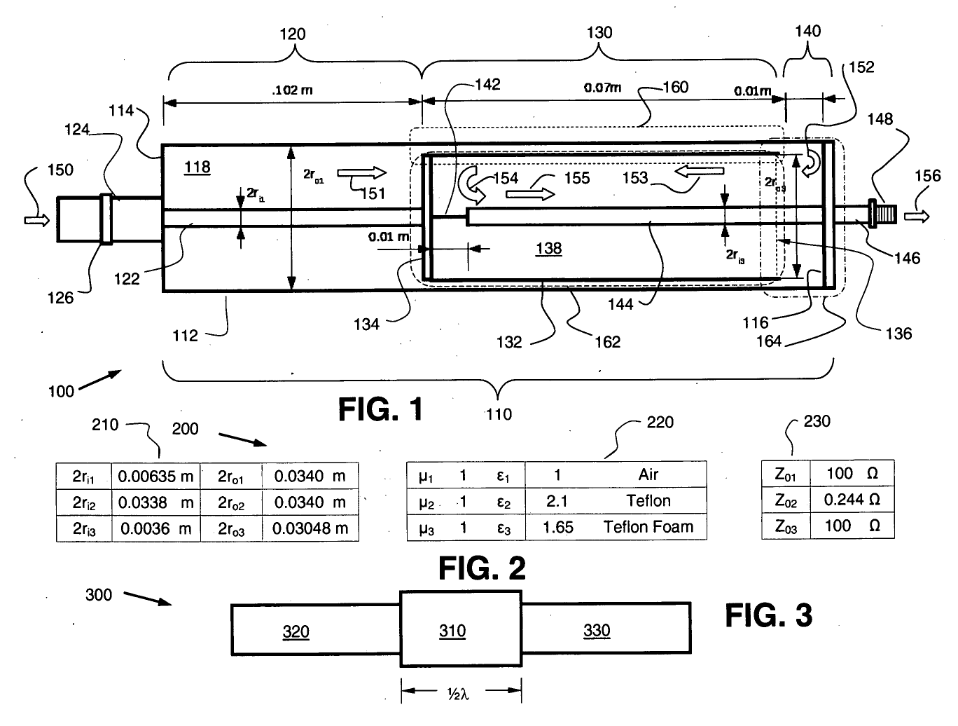

FIG. 1 shows an elevation cross-section view of a folded coaxial radio frequency (RF) mirror 100 in cross-section with inner and outer coaxial pipes. An outer tube assembly 110 comprises an outer cylindrical tube 112 bounded by an inlet end 114 and an outlet end 116 to define a first cavity 118 that includes a forward section 120 filled with air. In exemplary embodiments, the forward section 120 extends 0.102 meter in length. A fore rod 122 extends along the forward section 120. An inlet port 124, with a series-N coaxial connection 126, attaches upstream of the inlet end 114.

An inner tube assembly 130 includes an inner cylindrical tube 132 defined by an inlet end 134 and an open outlet boundary 136 to define a second cavity 138 that leads to an outlet section 140 filled with fluoropolymer foam. The terminal section 140 extends between the outlet boundary 136 and the outer end 116. In exemplary embodiments, the assembly 130 and the outlet section 140 respectively extend 0.07 meter and 0.01 meter in length. An electrically conductive pin 142 extends downstream from the inlet end 134 to an aft rod 144 that extends through the outlet end 116 to an outlet port 146 that attaches to an SMA-type connector 148. In exemplary embodiments, the pin 142 extends 0.01 meter.

An input signal 150 is received through the sleeve 126 and into the first cavity 118 travelling along the interior walls of the outer cylindrical tube 112 in a downstream direction 151. The signal travels along the annular concentric region between the inner wall of the outer cylindrical tube 112 and the outer wall of the inner cylindrical tube 132. The signal reverses propagation direction 152 upon reaching the open end 136 and proceeds to travel in the upstream direction 153 along the inner wall of the inner cylindrical tube 132. The signal reverses propagation direction 154 upon reaching the inlet end 134 and travels in the downstream direction 155 along the exterior of the aft rod 144 until exiting as an output signal 156.

The forward section 120 defines a first region for signal propagation filled with air. An annular envelope 160 defines a second region between the cylindrical tubes 112 and 132, which is enveloped with fluoropolymer, such as polytetrafluoroethylene under tradename Teflon®, such as wrapping with tape of that material. The cavity 138 minus the aft rod 144 contained in the inner cylindrical tube 132 and filled with fluoropolymer foam define the third region. The aft section 140, also filled with fluoropolymer foam, constitutes a terminal region before reaching signal exit.

FIG. 2 shows tabular lists 200 of dimensions and properties of the regions. The first tabular list 210 includes diameters in the three regions, the first pair of columns for the inner values, and the second pair of columns for the outer values. The second tabular list 220 includes the permeability p and the permittivity ε of the cavities of the three regions, with the filling materials identified alongside. The third tabular list 230 includes the impedances of the three regions.

In the first tabular list 210, the first row (for the first region) identifies the outer diameters of the fore rod 122 and the outer cylindrical tube 112. The second row (for the second region) identifies the outer diameters of the inner cylindrical tube 132 and the outer cylindrical tube 112. The third row (for the third region) identifies the inner diameter of the inner cylindrical tube 132 and the outer diameter of the aft rod 144. The diameters are denoted in the filter 100 as double-radii.

In the second tabular list 220, all regions have substantially similar relative magnetic permeability values, proportional to the vacuum value of 4π×10⁻⁷ N A⁻². Typical materials, ranging from copper and aluminum to water share approximately this value. By contrast, relative permittivity values vary from aluminum at −1300 to strontium titanate at +310, proportional to the vacuum value of 8.854×10⁻¹² A² s⁴ kg⁻¹ m⁻³. The relative permittivity of air is approximately unity, whereas 2.1 represents the corresponding value for Teflon®, and 1.65 provides an intermediate value of a mixture. In the third tabular list 230, the first and third (and terminal) regions have an impedance of 100Ω, and the second region has a lower impedance of 0.244Ω.

FIG. 3 presents a block diagram 300 of a narrow-band regenerative filter with a gain medium 310 flanked by an input mirror 320 and an output mirror 330. The mirrors 320, 330 are analogous to the coaxial mirror 100 that exhibits low losses. The medium 310 provides a limited gain of 3 dB intended to compensate for attenuation losses while avoiding amplification that causes signal oscillation. The medium 310 extends a half-wavelength (½λ) of the filtered signal. The oscillation behaves as an Airy function, which represents the solution of y=Ai(x) to the differential equation y″−xy=0. The mirrors 320, 330 reflect the signal passing through the medium 310 to enable detection of the weak return signal.

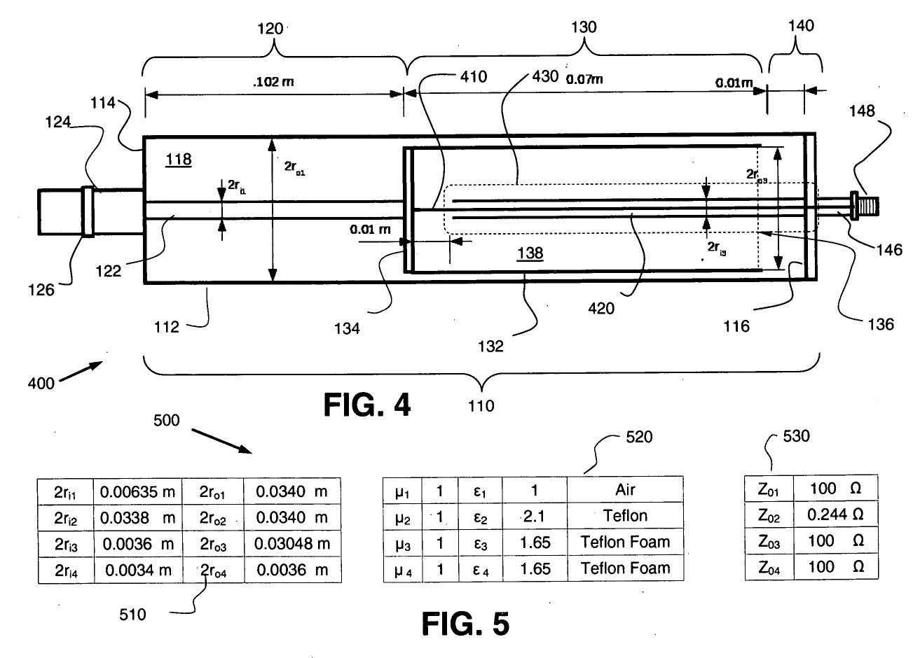

FIG. 4 shows an elevation cross-section view of a folded coaxial radio frequency (RF) mirror 400 in cross-section with inner and outer coaxial pipes as a secondary embodiment. A communication wire 410 extends coaxially through the inner tube assembly 130 and connects to the output connector 148. A hollow tube 420 coaxially envelopes the wire 410 across most of the length of the third and fourth regions. The tube 420 opens adjacent and downstream of the inlet end 134 to produce a fourth region 430 filled with fluoropolymer foam through which the signal travels.

FIG. 5 shows tabular lists 500 of dimensions and properties of the four regions. The fourth tabular list 510 includes diameters ; the fifth tabular list 520 provides the dielectric constants, with the filling materials identified along-side; the sixth tabular list 530 includes the impedances. The fourth region dimensions are defined by inner and outer diameters of the hollow tube 420, and the material characteristics correspond to fluoropolymer foam.

The folded coaxial RF mirror 100 is to be used in a field deployable RF Fabry-Perot interferometer used in a RF Brillouin Scattering radar. The mirror 100 reduces the overall size and increases the ruggedness of a more conventional RF mirror. Conventionally, a coaxial RF mirror may be constructed from co-linear concatenated sections of coaxial transmission line alternating between sections with high and low characteristic impedance. Because each section of the mirror is quarter-wavelength (¼λ) long at the center frequency of the mirror's operation, the conventional co-linear mirror can be quite lengthy at low frequencies.

For a mirror made from rigid materials, the need for a dielectric Bragg-mirror to have a high Q-resonation necessitates the construction of the mirror from a metal, such as copper, having very high conductivity. However, copper is a relatively soft metal and prone to bending or crushing, as well as being a difficult material to machine. Conceivably, a coaxial. RF mirror could also be constructed from flexible cable, but such a mirror would have degraded performance. This is because the performance of this mirror although improves as the impedance contrast increases, it can be-difficult to obtain a great deal of contrast between the characteristic impedances utilizing commercially available coaxial cable.

Multiple coaxial cables, such as assemblies 110 and 130, are nested within each other to achieve the requisite alternating high and low characteristic impedances. The radii are varied and dielectrics can be carefully selected to achieve the desired characteristic impedance in each section. The mirror 100 demonstrates an exemplary embodiment with three folded sections. However, the design can be easily extendable to an arbitrary number of folded sections.

The input side has a section of 50Ω transmission line of arbitrary length terminated with a General Radio Type 874 (GR874) connector 126 (or type-N) and the output side has a section of 50Ω semi-rigid coax of arbitrary length terminated with an SMA connector 148. In the cross-section diagram and the first table, the notation rᵢₙ signifies the radius of the inner conductor, and rₒₙ signifies the radius of the outer conductor of the n^{th} section of coaxial transmission line. This structure for the mirror 100 is thus physically shorter than the conventional design due to the nesting of the coaxial transmission lines. The mirror 100 can be constructed of silver or gold-plated brass to maintain the high Q and improve the ruggedness of the structure.

Interferometer tests have been conducted with three-and-one-half-wavelength (3½λ) quarter-wave tube of copper with slugs to provide mirror antenna for ultra-high-frequency (UHF) waves. The phenomenon absorption and release of energy by photons from electron shells via acoustic travel has been demonstrated in the past. This can also be accomplished with radio waves, but with greater power levels because signal resolution from scatter cross-section diminishes as the fourth power of frequency, as ω⁴, or of the wavelength inverse, as λ⁻⁴. Electromagnetic signals are typically employ much shorter wavelengths than acoustic signals.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A coaxial mirror reflecting for an electromagnetic signal, said mirror comprising:
an outer pipe extending between input and output ports, with closed initial and final terminals disposed at their respective ports;
an inner pipe extending between a closed fore end and an open aft end, said inner pipe being coaxially disposed between said initial and final terminals within said outer pipe;
a first rod, coaxially disposed within said outer pipe, extending from said input port to said fore end;
a second rod, coaxially disposed within said inner pipe, extending from downstream of said fore end to said output port;
a conductor, coaxially disposed within said inner pipe, extending from said fore end to said second rod.

2. The coaxial mirror according to claim 1, wherein said first and second pipes are cylindrical tubes.

3. The coaxial mirror according to claim 1, wherein an annular region between said inner and outer pipes is filled with a fluoropolymer, and an annular cavity within said inner pipe is filled with a foam containing said fluoropolymer.

4. The coaxial mirror according to claim 1, wherein said first pipe has an electrically conductive inner surface, said second pipe has electrically conductive inner and outer surfaces, and said first and second rods have conductive surfaces.

5. A coaxial mirror for reflecting an electromagnetic signal, said mirror comprising:
an outer pipe extending between input and output ports, with closed initial and final terminals disposed at their respective ports;
an inner pipe extending between a closed fore end and an open aft end, said inner pipe being coaxially disposed between said initial and final terminals within said outer pipe;
a solid rod, coaxially disposed within said outer pipe, extending from said input port to said fore end;
a hollow rod, coaxially disposed within said inner pipe, extending from an opening downstream of said fore end to said output port.

6. The coaxial mirror according to claim 5, wherein said first and second pipes are cylindrical tubes.

7. The coaxial mirror according to claim 5, wherein an annular region between said inner and outer pipes is filled with a fluoropolymer, a first annular cavity within said inner pipe is filled with a foam containing said fluoropolymer, and a second annular cavity within said hollow rod is filled with said foam.

8. The coaxial mirror according to claim 5, wherein said first pipe has an electrically conductive inner surface, said second pipe has electrically conductive inner and outer surfaces, and said solid and hollow rods have conductive surfaces.
